(19) United States
(12) Patent Application Publication
(10) Pub. No.: US 2011/0064430 A1
(43) Pub. Date: Mar. 17, 2011

(54) IMAGE FORMING METHOD AND DETERMINATION METHOD OF CONTRAST POTENTIAL

(75) Inventors: Hiromichi Mitamura, Shizuoka (JP); Hirotaka Fukuyama, Shizuoka (JP); Sunao Takenaka, Kanagawa (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/872,113

(22) Filed: Aug. 31, 2010

Related U.S. Application Data
(60) Provisional application No. 61/242,986, filed on Sep. 16, 2009.
(60) Provisional application No. 61/245,007, filed on Sep. 23, 2009.

(51) Int. Cl. G03G 15/08

(52) U.S. Cl. 399/27; 399/44; 399/257

(57) ABSTRACT

In an image forming method, an execution condition of forcible toner consumption is obtained based on an environmental value at a time of final image formation and a present environmental value, the forcible toner consumption is executed under the execution condition, and image formation is performed after calibration.

### CROSS-REFERENCE TO RELATED APPLICATION

This application is based upon and claims the benefit of priority from the prior U.S. Patent Application 61/242,986 filed on Sep. 16, 2009, and 61/245,007 filed on Sep. 23, 2009, the entire contents of which are incorporated herein by reference.

### FIELD

The present invention relates to an image forming method and a determination method of a contrast potential

### BACKGROUND

In an electrophotographic image forming apparatus, a photoconductive surface as an image carrier is charged and an electrostatic latent image is formed by exposure. A developer including a charged toner is supplied to the electrostatic latent image, and after development, a developed image is transferred to a transfer medium such as paper.

In the electrophotographic process as stated above, in order to print a high quality image, it is necessary to keep the charging amount of the developer to be constant. However, in a long non-operation period or during storage under high humidity environment, the developer is discharged and the charging amount is reduced. Thus, there arises a problem that at printing immediately after such storage, a desired image density or gradation can not be obtained.

Then, before the printing after the storage, calibration is performed in which a specified latent image is formed on a photoreceptor, and an image formation condition for image density or the like is optimized. However, there is a problem that when continuous printing is performed after the calibration, by the agitation of the developer the absolute value of the charging amount of the developer is increased, and the image density is gradually reduced.

Thus, in order to replace a part of the toner whose charging amount is reduced and in which the charging amount change is liable to occur, forcible toner consumption (refresh) to forcibly consume the toner is performed before the printing after the storage. After the execution of the forcible toner consumption, the calibration is again performed, so that a stable image can be obtained in the printing after that.

Before the execution of the forcible toner consumption, it is necessary to perform calibration in order to adjust the toner consumption amount to a specific amount. However, there is a problem that by the calibration before or after the execution of the forcible toner consumption, time elapsed before the printing after the storage becomes possible becomes long.

### BRIEF DESCRIPTION OF THE DRAWINGS

FIG. 1 shows a structure of an image forming apparatus in an embodiment of the invention;

FIG. 2 shows a structure of an image forming section in the embodiment of the invention;

FIGS. 3, 6 and 8 are flowcharts of image formation in the embodiment of the invention;

FIG. 4 shows a relation between a development contrast potential and a relative humidity in the embodiment of the invention;

FIG. 5 shows an estimation method of a development contrast potential in the embodiment of the invention;

FIGS. 7A and 7B show tables of toner replacement amounts corresponding to respective parameters in the embodiment of the invention.

### DETAILED DESCRIPTION

Reference will now be made in detail to the present embodiment of the invention, an example of which is illustrated in the accompanying drawing.

Hereinafter, embodiments will be described with reference to the drawings.

### Embodiment 1

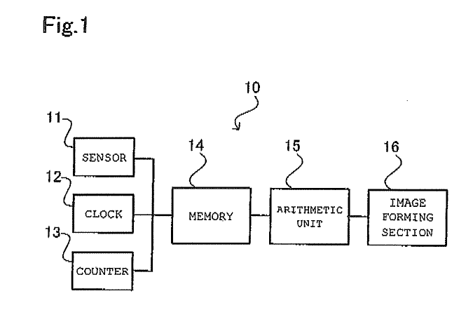

FIG. 1 shows a structure of an image forming apparatus 10 in this embodiment. As shown in the drawing, a sensor 11 to acquire an environmental value such as a relative humidity, a clock 12 to acquire a non-operation time or an operation time as needed, and a counter 13 to acquire a developer life (the number of processed sheets for an inputted developer) are provided. These are connected to a memory 14 which stores the environmental value such as the relative humidity, the developer life, and a correlation between these and an image formation condition such as a development contrast potential (difference between a toner attachment side electrostatic latent image potential and a development potential).

The memory 14 is connected to an arithmetic unit 15 to obtain an image formation condition or the like. The arithmetic unit 15 is connected to an image forming section 16 which includes an exposure device, a photoreceptor, a developing device and the like and forms an image under the obtained image formation condition.

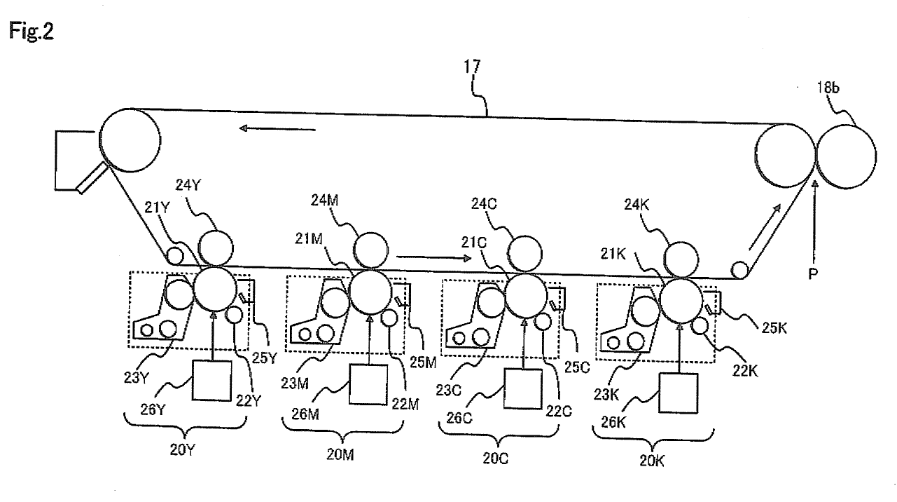

Incidentally, in the image forming apparatus as stated above, the image forming section can be constructed as shown in FIG. 2. As shown in FIG. 2, a secondary transfer roller 18b to transfer an image on an intermediate transfer belt 17 onto a transfer medium P and image forming units 20_{Y}, 20_{M}, 20_{C} and 20_{K} are arranged along a conveyance direction (arrow direction) of the intermediate transfer belt 17.

The image forming units 20_{Y}, 20_{M}, 20_{C} and 20_{K} respectively includes photoreceptors 21_{Y}, 21_{M}, 21_{C} and 21_{K}. Further, charging devices 22_{Y}, 22_{M}, 22_{C} and 22_{K} having charging members as charging units and gap adjustment mechanisms and developing rollers as developing members are provided around the respective photoreceptors. The image forming units 20_{Y}, 20_{M}, 20_{C} and 20_{K} further include developing devices 23_{Y}, 23_{M}, 23_{C} and 23_{K} containing developers made of respective color toner particles of yellow, magenta, cyan and black and carrier particles, primary transfer rollers 24_{Y}, 24_{M}, 24_{C} and 24_{K} as transfer units, and cleaner units 25_{Y}, 25_{M}, 25_{C} and 25_{K}. These are respectively arranged along the rotation directions of the corresponding photoreceptors 21_{Y}, 21_{M}, 21_{C} and 21_{K}.

The respective primary transfer rollers 24_{Y}, 24_{M}, 24_{C} and 24_{K} are arranged inside the intermediate transfer belt 10, and nip the intermediate transfer belt 17 in cooperation with the corresponding photoreceptors 21_{Y}, 21_{M}, 21_{C} and 21_{K}. Exposure devices 26_{Y}, 26_{M}, 26_{C} and 26_{K} are respectively arranged so that exposure points are formed on the outer peripheral surfaces of the photoreceptors 21_{Y}, 21_{M}, 21_{C} and 21_{K} between the charging devices 22_{Y}, 22_{M}, 22_{C} and 22_{K} and the developing devices 23_{Y}, 23_{M}, 23_{C} and 23_{K}. The secondary transfer roller 18b is arranged outside the intermediate transfer belt 17 so as to contact therewith.

In the image forming apparatus constructed as stated above, first, a toner image is formed by the image forming unit 20Y. In synchronization with the timing of the toner image of yellow formation in the image forming unit 20_{Y}, the same process is performed also in the image forming units 20_{M}, 20_{C} and 20_{K}. The toner images of magenta, cyan and black formed on the photoreceptors of the image forming units 20_{M}, 20_{C} and 20_{K} are also successively primarily transferred onto the intermediate transfer belt 17.

The transfer medium P is conveyed from a cassette (not shown), and is sent by an aligning roller (not shown) in synchronization with the timing to the toner image on the intermediate transfer belt 17.

A bias (+) of reverse polarity to the charging polarity of the toner is applied to the secondary transfer roller 18b by a power source (not shown). As a result, the toner image on the intermediate transfer belt 17 is transferred onto the transfer medium P by a transfer electric field formed between the intermediate transfer belt 17 and the secondary transfer roller 18b. A fixing device (not shown) for fixing the toner transferred on the transfer medium P is arranged, and a fixed image is obtained by causing the transfer medium P to pass through the fixing device.

Incidentally, although the description is made on the example in which the image forming units are arranged in color order of yellow, magenta, cyan and black, the color order is not particularly limited. Besides, only the black image formation unit may be used.

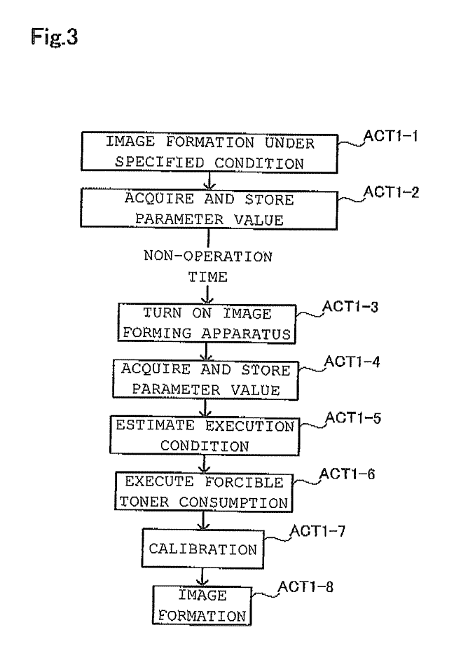

By using the image forming apparatus having the structure as stated above, image formation is performed as shown in, for example, a flowchart of FIG. 3.

A parameter value at the time of final image formation and an image formation condition are previously acquired. The image formation is performed under a specified image formation condition (ACT 1-1), the sensor 11 acquires an environmental value, such as a relative humidity, at the time of final image formation, and the counter 13 acquires a parameter value, such as a developer life, at the time of final image formation. The acquired environmental value, together with the image formation condition, such as a development contrast, at the time of final image formation, is stored in the memory 14 in the image forming apparatus 10 (ACT 1-2). Thereafter, a power source of the image forming apparatus 10 is turned OFF.

After being left standing for a week, the image forming apparatus is returned from the sleep state by turned ON the power source thereof (ACT 1-3). Before image formation is again performed, the present relative humidity is similarly acquired and is stored in the memory 14 in the image forming apparatus (ACT 1-4).

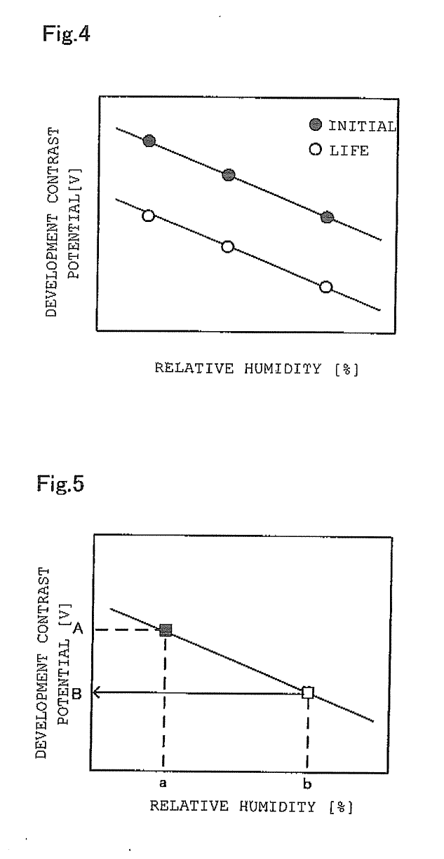

Here, FIG. 4 shows a relation between a development contrast potential as an image formation condition and a relative humidity. As shown in FIG. 4, in the initial developer, the development contrast potential to obtain a specified image contrast is proportional to the relative humidity. In addition, the value of a life developer as the developer after 20 k processing is shown. Although the development contrast potential to the relative humidity is reduced from that of the initial developer, the inclination is almost the same. That is, irrespective of the life, the inclination of the variation of the development contrast potential to the relative humidity is almost constant.

Accordingly, in the arithmetic unit 15, as shown in FIG. 5, a development contrast potential “A” to a stored relative humidity “a” at the time of final image formation is plotted, and on a straight line passing through the plotted point and having the inclination shown in FIG. 4, an image contrast potential “B” corresponding to the stored present relative humidity “b” is obtained. In this way, without performing after-mentioned calibration, the optimum development contrast potential as the execution condition is estimated (ACT 1-5).

Next, at the estimated image contrast potential, forcible toner consumption (refresh) is performed in the image forming section 16 (ACT 1-6). A consumed amount of toner is newly supplied, so that partial replacement of toner in the developing device to supply the developer is performed.

After completion of the forcible toner consumption, and before image formation, the calibration is performed (ACT 1-7). Here, a specified latent image is formed on the photoreceptor and is developed, the density (attachment amount) is measured on the secondary transfer belt, and the image formation condition such as an image contrast potential, a charging bias voltage, or an exposure intensity is optimized. The image formation is performed in the image forming section 16 under the optimized image formation condition (ACT 1-8).

In this way, since the execution condition of the forcible toner consumption is estimated before the image formation, the forcible toner consumption can be performed without calibration, and a time elapsed before the start of image formation can be shortened. Further, in the subsequent continuous image formation, a change of image density or the like is suppressed, and stable image formation can be performed.

Incidentally, in this embodiment, although the relative humidity having a relatively high influence on the toner charging amount is mentioned as the environmental value, another condition such as a temperature may be used. Besides, when a variation of the environmental value such as the relative humidity is small, the execution condition of the forcible toner consumption may be obtained based on another parameter having an influence on the toner charging amount.

For example, the execution condition may be obtained based on a non-operation time before image formation. The non-operation time can be obtained by the clock 12. Further, the execution condition may be obtained based on a developer life. The developer life can be acquired by the counter 13.

It is preferable that the estimation of the execution condition of the forcible toner consumption is performed at every start of image formation. Besides, the estimation may be set to be performed when the non-operation time or the developer life exceed a specified value.

### Embodiment 2

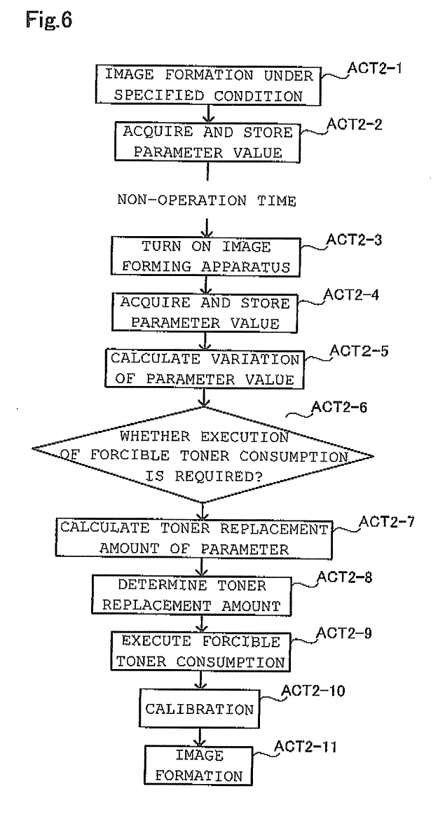

In this embodiment, although the same image forming apparatus as that of embodiment 1 is used, there is a difference that an execution condition of forcible toner consumption is stepwise set based on a variation amount of a parameter. For example, image formation is performed as shown in a flowchart of FIG. 6.

Similarly to embodiment 1, image formation is performed under a specified image formation condition (ACT 2-1), the sensor 11 acquires an environmental value, such as a relative humidity, at the time of final image formation, and the clock 12 acquires the date and time of the final image formation. They are stored in the memory 14 in the image forming apparatus 10 (ACT 2-2). Thereafter, the power source of the image forming apparatus 10 is turned OFF.

After being left standing for one week, the image forming apparatus is returned from the sleep state by turning ON the power source thereof (ACT 2-3). Before image formation is again performed, for example, the present relative humidity and the date and time are similarly acquired and are stored in the memory 14 in the image forming apparatus (ACT 2-4).

In the arithmetic unit 15, a humidity change as a variation of a parameter value and a non-operation time are calculated from the relative humidity and the date and time at the time of final image formation and those at the present time, which are stored in the memory 14 (ACT 2-5). The necessity of execution of the forcible toner consumption is determined for each of the parameters (ACT 2-6). For example, when the humidity change is a specified value or more, or the non-operation time is a specified time or more, it is determined that the execution is necessary.

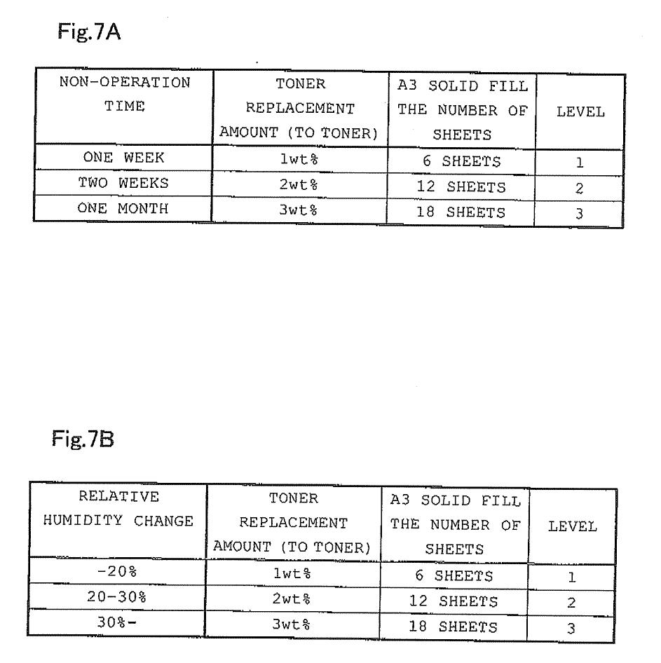

With respect to the parameter for which it is determined that the execution is necessary, a toner replacement amount as an execution condition is obtained (ACT 2-7). The toner replace amount can be obtained from tables as shown in FIGS. 7A and 7B, each of which includes the toner replacement amount corresponding to each parameter value and is previously stored in the memory 14.

The toner replacement amounts for the respective parameters are compared with each other, and a larger one (higher level) is selected, so that the toner replacement amount is determined (ACT 2-8), and the forcible toner consumption is executed (ACT 2-9). At this time, for example, an image contrast potential is made constant, a specified pattern such as a solid fill is formed on A3 transfer media the number of which corresponds to the toner replacement amount, and a specified amount of toner is discharged. A consumed amount of developer is newly supplied, so that the toner in the developing device to supply the developer is partially replaced.

After the forcible toner consumption is completed, similarly to embodiment 1, calibration is performed before image formation (ACT 2-10). Then, the image formation is performed in the image forming section 16 under the optimized image formation condition (ACT 2-11).

As described above, the suitable forcible toner consumption can be easily performed by obtaining the execution condition from the tables of the toner replacement amounts corresponding to the values of the respective parameters. In the subsequent continuous image formation, the change of image density or the like is suppressed, and the stable image formation can be performed.

In embodiments 1 and 2, it is preferable that the forcible toner consumption is automatically performed at every start of image formation in order to maintain the picture quality. Besides, the forcible toner consumption may be performed by forming an image pattern corresponding to a previously set replacement toner amount at a specified time. For example, this is effective for a case where after a small number of sheets are intermittently printed for a long period, continuous printing is performed with high picture quality.

### Embodiment 3

In this embodiment, although the same image forming apparatus as that of embodiment 1 is used, there is a difference that not an execution condition for forcible toner consumption, but an image formation condition updated during image formation is estimated.

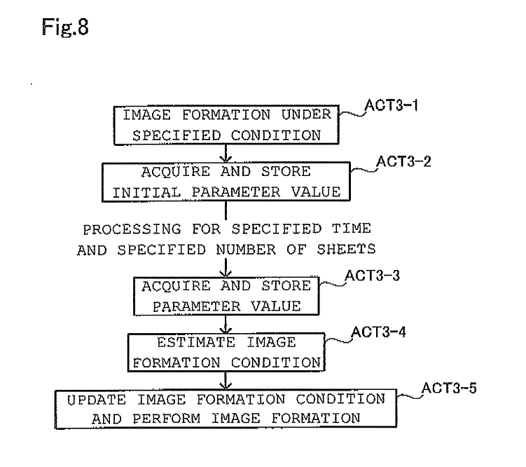

Similarly to the estimation of the execution condition of the forcible toner consumption of embodiment 1, as shown in a flowchart of FIG. 8, image formation is performed under the initial image formation condition of a development contrast potential or the like (ACT 3-1). At the time of start of image formation, as initial parameter values, an initial environmental value such as a relative humidity is acquired by the sensor 11, an initial date and time is acquired by the clock 12, and an initial developer life is acquired by the counter 13 (ACT 3-2), and the values are stored in the memory 14.

When a specified time elapses or a specified number of sheets are processed from the start of image formation, parameter values such as an environmental value, a date and time, and a developer life are similarly acquired (ACT 3-3). Similarly to embodiment 1, the arithmetic unit 15 estimates the presently optimum image formation condition based on the correlation between the image formation condition and each parameter, the initial image formation condition and initial parameter values, which are previously obtained and stored in the memory 14, and the acquired parameter values (ACT 3-4).

The image formation condition in the image forming section 16 is updated to the estimated condition, and the image formation is continued (ACT 3-5).

Even in the image formation such as continuous printing, the environmental value such as the relative humidity and the developer life are changed. Besides, the toner charging amount is changed also by the image formation time. Thus, until now, calibration is performed at intervals of a specified time or a specified number of sheets. However, for the calibration, it is necessary to once stop the apparatus for a certain time.

According to the embodiment, the respective parameter values are acquired during the image formation, and the image formation condition can be updated based on these parameter values. Thus, the image formation can be continued without stopping the apparatus for a long time.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section configured to form a developer image on an image carrier;
a detection section configured to detect, when the image forming apparatus is used, an elapsed time in which the image forming apparatus is not used after a time of final image formation or magnitude of environmental change as compared with an environment at the time of final image formation; and
a developer consumption section configured to consume a developer by forcibly attaching the developer to the image carrier under a specified condition when the unused time or the environmental change exceeds a specified value based on a detection result of the detection section.

2. The image forming apparatus according to claim 1, further comprising a memory to store data detected by the detection section and a correlation between the data and the specified condition.

3. The image forming apparatus according to claim 1, further comprising an arithmetic unit connected to the detection section and obtains the specified condition.

4. An image forming method comprising:
obtaining an execution condition of forcible toner consumption based on an environmental value at a time of final image formation and a present environmental value;
executing the forcible toner consumption under the execution condition; and
performing image formation after calibration.

5. The image forming method according to claim 4, wherein the execution condition is obtained based on a non-operation time.

6. The image forming method according to claim 4, wherein the execution condition is obtained based on a present developer life.

7. The image forming method according to claim 4, wherein the execution condition is obtained based on a previously obtained correlation between the environmental value and the execution condition.

8. The image forming method according to claim 4, wherein the environmental value is a relative humidity.

9. The image forming method according to claim 8, wherein the execution condition is a condition of an development contrast potential.

10. The image forming method according to claim 9, further comprising:
detecting the present relative humidity; and
determining a new image contrast potential based on the detected present relative humidity, the detected relative humidity at the time of final image formation and the image contrast potential at the time of final image formation, and a previously obtained inclination of a variation of the image contrast potential to the relative humidity.

11. The image forming method according to claim 4, wherein agitation of the developer, together with the forcible toner consumption, is performed.

12. The image forming method according to claim 4, wherein at least one of a date and time, a humidity and a developer life is stored at a time of image formation end.

13. The image forming method according to claim 4, wherein the forcible toner consumption is performed at every start of image formation or at a specified time.

14. An image forming method comprising:
detecting at least one parameter of an environmental value, a developer life and an image formation time during image formation;
updating an image formation condition based on the parameter; and
performing image formation.

15. The image forming method according to claim 14, wherein the environmental value is a relative humidity.

16. The image forming method according to claim 14, wherein the image formation condition is at least one condition of a development contrast potential, a charging bias voltage and an exposure intensity.

17. The image forming method according to claim 14, wherein the updating is performed at intervals of a specified time or a specified number of processed sheets.

18. A determination method of a development contrast potential, comprising:
detecting a present relative humidity; and
determining a new image contrast potential based on the detected present relative humidity, a previously detected relative humidity at a time of image formation and an image contrast potential at the time of image formation, and a previously obtained inclination of a variation of an image contrast potential to a relative humidity.

19. The determination method according to claim 18, wherein the inclination of the variation is obtained from an average of the inclination of the variation of an initial developer and a specified life developer.

20. The determination method according to claim 18, wherein the new contrast potential is determined by plotting the image contrast potential to the previously detected relative humidity at the time of image formation in a relation between a relative humidity and an image contrast potential image formation condition, and
obtaining an image contrast potential corresponding to the present relative humidity on a straight line passing through the plotted point and having the inclination of the variation.
